(19) United States
(12) Patent Application Publication
(10) Pub. No.: US 2023/0195998 A1
(43) Pub. Date: Jun. 22, 2023

(54) SAMPLE GENERATION METHOD, MODEL TRAINING METHOD, TRAJECTORY RECOGNITION METHOD, DEVICE, AND MEDIUM

(71) Applicant: Beijing Baidu Netcom Science Technology Co., Ltd., Beijing (CN)

(72) Inventors: Yunze GAO, Beijing (CN); Xiaoping WANG, Beijing (CN); Penghao RAO, Beijing (CN); Fenfen SHENG, Beijing (CN); Mingxin LIANG, Beijing (CN)

(21) Appl. No.: 17/952,556

(22) Filed: Sep. 26, 2022

(30) Foreign Application Priority Data
Dec. 20, 2021 (CN) 202111566778.5

(51) Int. Cl. G06F 40/129; G06F 40/123; G06N 5/02

(52) U.S. Cl. CPC G06F 40/129; G06F 40/123; G06N 5/022

(57) ABSTRACT

Disclosed are a sample generation method, a model training method, a trajectory recognition method, a device, and a medium. The method is: determining a code result of a training Chinese character according to a preset code library, where the preset code library is generated based on code characters in a five-stroke code corpus; taking the code result as a training label of the training Chinese character; and generating a training sample according to both a writing trajectory and the training label of the training Chinese character. The amount of information carried in the training sample is enriched.

### CROSS-REFERENCE TO RELATED APPLICATION

This application claims the priority from Chinese Patent Application No. 202111566778.5 filed on Dec. 20, 2021, which is hereby incorporated by reference in its entirety.

### TECHNICAL FIELD

The present disclosure relates to the field of artificial intelligence, in particular, to the technology of natural language processing and deep learning and, specifically, a sample generation method and apparatus, a model training method and apparatus, a trajectory recognition method and apparatus, a device, and a medium.

### BACKGROUND

With the overall popularization of smart terminals, it is increasingly important how to perform a convenient and fast human-computer interaction (HCl). Compared with the conventional input method such as a keyboard, the handwritten input does not need to change a writing habit of a user and does not need to memorize any code so that the user can input words most naturally and conveniently, and such an input method is easy to learn and use and has good availability and adaptability.

### SUMMARY

The present disclosure provides a sample generation method and apparatus, a model training method and apparatus, a trajectory recognition method and apparatus, a device, and a medium.

According to an aspect of the present disclosure, a training sample generation method is provided. The method includes the steps described below.

A code result of a training Chinese character is determined according to a preset code library, where the preset code library is generated based on code characters in a five-stroke code corpus.

The code result is taken as a training label of the training Chinese character.

A training sample is generated according to both a writing trajectory and the training label of the training Chinese character.

According to another aspect of the present disclosure, a trajectory recognition model training method is provided. The method includes steps described below.

A training sample is acquired, where the training sample is obtained based on any training sample generation method provided by the embodiments of the present disclosure.

A pre-constructed neural network model is trained according to both a writing trajectory and a training label of a training Chinese character in the training sample to obtain a trajectory recognition model.

According to an aspect of the present disclosure, a trajectory recognition method is provided. The method includes the steps described below.

A to-be-recognized trajectory is acquired.

A code prediction result of the to-be-recognized trajectory is determined according to a trajectory recognition model, where the trajectory recognition model is obtained based on any trajectory recognition model training method provided by the embodiments of the present disclosure.

A Chinese character recognition result corresponding to the code prediction result is determined according to the preset code library.

According to another aspect of the present disclosure, an electronic device is provided. The electronic device includes at least one processor and a memory communicatively connected to the at least one processor.

The memory stores instructions executable by the at least one processor, where the instructions are executed by the at least one processor to enable the at least one processor to perform any one of the training sample generation method, the trajectory recognition model training method and the trajectory recognition method provided by the embodiments of the present disclosure.

According to another aspect of the present disclosure, a non-transitory computer-readable storage medium is further provided. The non-transitory computer-readable storage medium is used for enabling a computer to perform any one of the training sample generation method, the trajectory recognition model training method and the trajectory recognition method provided by the embodiments of the present disclosure.

According to the technology of the present disclosure, the amount of information carried in the training sample is enriched.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure. In the drawings:

FIG. 1 is a flowchart of a training sample generation method according to an embodiment of the present disclosure;

FIG. 2A is a flowchart of another training sample generation method according to an embodiment of the present disclosure;

FIG. 2B is a schematic diagram of the five-stroke code split process of the corpus Chinese characters according to an embodiment of the present disclosure;

FIG. 3 is a flowchart of another training sample generation method according to an embodiment of the present disclosure;

FIG. 4 is a flowchart of a trajectory recognition model training method according to an embodiment of the present disclosure;

FIG. 5A is a flowchart of another trajectory recognition model training method according to an embodiment of the present disclosure;

FIG. 5B is a structural diagram of a neural network model according to an embodiment of the present disclosure;

FIG. 6 is a flowchart of a trajectory recognition method according to an embodiment of the present disclosure;

FIG. 7 is a structural diagram of a training sample generation apparatus according to an embodiment of the present disclosure;

FIG. 8 is a structural diagram of a trajectory recognition model training apparatus according to an embodiment of the present disclosure;

FIG. 9 is a structural diagram of a trajectory recognition apparatus according to an embodiment of the present disclosure; and

FIG. 10 is a block diagram of an electronic device for implementing a training sample generation method, a trajectory recognition model training method or a trajectory recognition method according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, the description of well-known functions and constructions is omitted hereinafter for clarity and conciseness.

The training sample generation method provided by the embodiments of the present disclosure is suitable for the scenario where a training sample is generated in a case where a trajectory recognition model is trained based on a writing trajectory of a training Chinese character. The training sample generation method provided by the present disclosure can be executed by a training sample generation apparatus. The apparatus can be implemented by software and/or hardware and is specifically configured in an electronic device.

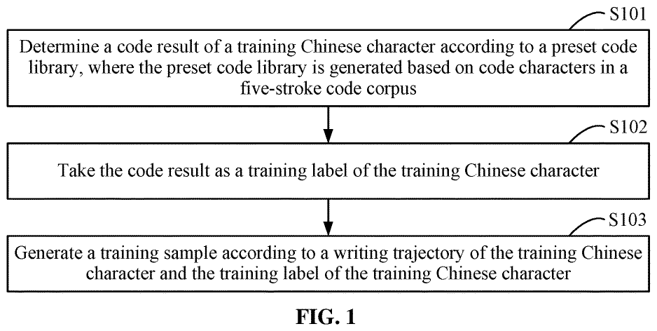

With reference to FIG. 1, the training sample generation method includes S101, S102 and S103.

In S101, a code result of a training Chinese character is determined according to a preset code library, where the preset code library is generated based on code characters in a five-stroke code corpus.

The five-stroke code corpus includes five-stroke codes of corpus Chinese characters, where the five-stroke code is a shape code result obtained after a Chinese character is encoded according to strokes and character pattern characteristics of the Chinese character. The five-stroke code is obtained by combining at least one code character in a set order. The code character herein is a constituent unit in the five-stroke code. For example, the five-stroke code corpus includes the five-stroke code “wyc” corresponding to Chinese character “ [symbol] ”, where “w”, “y” and “c” may be used as single code characters, and at least one of “wy”, “yc”, “wyc” and the like may be used as a combined code character, that is, a non-single code character.

The training Chinese character may be understood as a Chinese character of a to-be-generated training sample.

It is to be understood that since the preset code library is generated based on the code characters in the five-stroke code corpus, the code results in each code library are preset. Therefore, when the code result of the training Chinese character is determined based on the preset code library, the determined code result carries the strokes and character pattern characteristics of the training Chinese character, thereby improving the richness of the information carried in the code result.

For example, the training Chinese character is disassembled according to the character pattern to obtain at least one to-be-queried character pattern; a character pattern code of each to-be-queried character pattern is determined; and the character pattern code of each to-be-queried character pattern is combined in sequence according to a stroke order to obtain the code result of the training Chinese character.

In S102, the code result is taken as a training label of the training Chinese character.

In the training stage of a machine learning model in the artificial intelligence field, a machine learning task of a function is usually derived from a labelled training data set using a supervised learning method. The training sample in the present disclosure is the sample data carrying the label information in the supervised learning process, that is, the code result of the training Chinese character is taken as the training label of the training Chinese character.

It is to be noted that the training Chinese character corresponding to one training label may be one Chinese character or at least two Chinese characters, and the present disclosure does not limit the number of Chinese characters represented by one group of training Chinese characters.

In S103, a training sample is generated according to a writing trajectory of the training Chinese character and the training label of the training Chinese character.

The writing trajectory of the training Chinese character may be understood as a trajectory point coordinates sequence generated when the training Chinese character is written. The writing trajectory carries content information such as the length and angle of each stroke and position information such as the writing order and the relative position.

Since the writing trajectory of the training Chinese character carries the content information and the position information and the training label carries stroke information and character pattern information, the training sample is generated according to the writing trajectory of the training Chinese character and the training label of the training Chinese character, thereby improving the richness of the information carried in the training sample. Accordingly, when the subsequent trajectory recognition model is trained based on the training sample, the precision of the trajectory recognition model is improved so that the accuracy of the trajectory recognition result obtained when the trajectory recognition model is used is improved.

On the basis of the solutions described above, the present disclosure further provides an optional embodiment. In this optional embodiment, the generation process of the preset code library is optimized and improved. For the part that is not described in detail in the present disclosure, reference may be made to the related description of other embodiments.

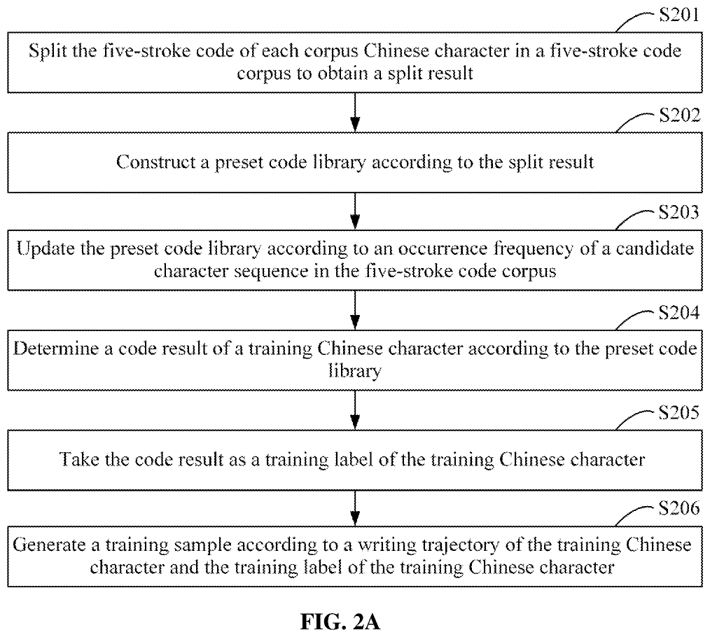

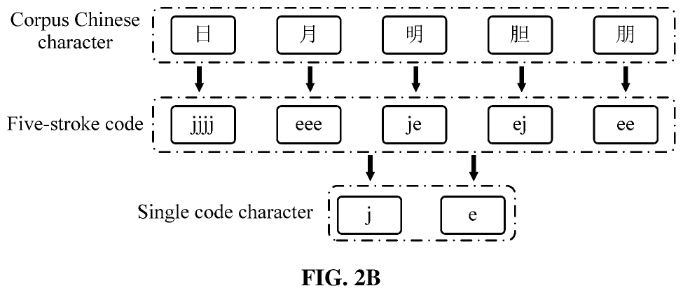

With reference to FIG. 2A, the training sample generation method includes S201, S202, S203, S204, S205 and S206.

In S201, a five-stroke code of each corpus Chinese character in a five-stroke code corpus is split.

For example, each five-stroke code may be split directly according to the number of single code characters carried by the five-stroke code of each corpus Chinese character in the five-stroke code corpus to obtain multiple single code characters; and each single code character is de-duplicated to update the single code characters.

For another example, the sliding window splitting may also be performed on the five-stroke code of each corpus Chinese character in the five-stroke code corpus according to a preset character window to obtain a split result, where the window size of the preset character window herein may be determined according to the size of a single code character, For example, the window size of the preset character window may be an integer multiple of the single code character. For example, if the integer value is 1, the obtained split result is a single code character; and if the integer value is not less than 2, the obtained split result is an adjacent character sequence including at least two consecutive single code characters.

In S202, a preset code library is constructed according to a split result.

For example, an empty preset code library may be pre-constructed, and each split result is added to the preset code library. The split result includes each single code character. In order to further enrich the amount of data in the preset code library, optionally, at least one adjacent character sequence may also be added to the preset code library; or optionally, a combination result of at least two single code characters may be added to the preset code library.

FIG. 2B is a schematic diagram illustrating the split process where the five-stroke codes of different corpus Chinese characters are split to obtain the single code character split results. The five-stroke code of Chinese character “ [symbol] ” is “jjjj”, the five-stroke code of Chinese character “ [symbol] ” is “eee”, the five-stroke code of Chinese character “ [symbol] ” is “je”, the five-stroke code of Chinese character “ [symbol] ” is “ej”, and the five-stroke code of Chinese character “ [symbol] ” is “ee”. Accordingly, after the five-stroke codes are split and de-duplicated, the obtained single code characters are “j” and “e”, respectively. “ [symbol] ” and “e” are added to the preset code library, and single code characters are ordered and combined to obtain different corpus Chinese characters with the same or similar character patterns, thereby reducing the number of elements in the preset code library, reducing the occupation of storage resources of the preset code library, and reducing the computation amount for subsequent trajectory recognition model training.

In S203, the preset code library is updated according to an occurrence frequency of a candidate character sequence in the five-stroke code corpus. The candidate character sequence consists of at least two single code characters.

Optionally, the candidate character sequence may be a character string obtained by combining at least two single code characters in sequence. For example, for the five-stroke code “wyc” corresponding to Chinese character “ [symbol] ”, the candidate character sequence generated according to the manner described above is obtained by combining at least two of the single code characters “w”, “y” and “c”, that is, the candidate character sequence includes “wy”, “wc”, “yw”, “yc”, “cw”, “cy”, “wyc”, “wcy”, “ywc”, “yew”, “cwy” and “cyw”. Of course, in order to avoid the interference of irrelevant information, the universal character string may also be selected from the combination results as the candidate character sequence, such as “wy” and “wycn”.

Optionally, the candidate character sequence may be an adjacent character sequence obtained by splitting the five-stroke code of each corpus Chinese character in the five-stroke code corpus. For example, for the five-stroke code “wyc” corresponding to Chinese character “ [symbol] ”, the candidate character sequence generated according to the manner described above may include “wy”, “yc” and “wyc”.

The occurrence frequency of the candidate character sequence in the five-stroke code corpus represents the recurrence of the candidate character sequence in the five-stroke code corpus. Therefore, the universality of the candidate character sequence may be measured through this occurrence frequency. Accordingly, the candidate character sequence with a high occurrence frequency, that is, the candidate character sequence with good universality, is selected and added to the preset code library to perform the increment processing on the preset code library; or the candidate character sequence with a low occurrence frequency, that is, the candidate character sequence with poor universality, is selected and removed from the preset code library to perform the decrement processing on the preset code library.

In S204, a code result of a training Chinese character is determined according to the preset code library.

In S205, the code result is taken as a training label of the training Chinese character.

In S206, a training sample is generated according to a writing trajectory of the training Chinese character and the training label of the training Chinese character.

In this embodiment of the present disclosure, the preset code library is constructed according to the split result of each five-stroke code in the five-stroke code corpus, and the preset code library is updated according to the occurrence frequency of the candidate character sequence consisting of at least two single code characters in the five-stroke code corpus so that the code characters carried in the preset code library are more universal, thereby improving the universality of the training sample generation process for different training Chinese characters.

In an optional embodiment, the split result may include a single code character and an adjacent character sequence. Accordingly, the step in which the preset code library is constructed according to the split result may be: a preset code library including single code characters is generated so that the code characters in the preset code library are enriched by performing increment processing on the preset code library.

For example, the step in which the preset code library is updated according to the occurrence frequency of the candidate character sequence in the five-stroke code corpus may be: the adjacent character sequence is taken as the candidate character sequence, and a candidate character sequence whose occurrence frequency in the five-stroke code corpus satisfies a preset frequency condition is added to the preset code library to update the preset code library.

The preset frequency condition may be determined by those skilled in the art according to the actual situation.

In an optional embodiment, the occurrence frequencies of different candidate character sequences in the five-stroke code corpus may be determined, and the candidate character sequences whose occurrence frequency is greater than a preset frequency threshold and/or the candidate character sequences whose number reaches a set number threshold and whose occurrence frequency is higher are selected and added to the preset code library to update the preset code library. The specific values of the preset frequency threshold and/or the set number threshold may be determined by technicians according to requirements or empirical values or adjusted through a large number of trials.

In an optional embodiment, in order to reduce the amount of data in the five-stroke code corpus and reduce the code length when the training Chinese character is encoded based on the preset code library, the candidate character sequence that satisfies the preset frequency condition may be replaced by a new single code character which has not been used in the preset code library, and the new single code character may be added to the preset code library to update the preset code library.

Optionally, when the number of code characters in the updated preset code library reaches a preset number threshold, the addition of the candidate character sequence to the preset code library is stopped, thereby stopping the update operation on the preset code library. The preset number threshold may be determined by technicians according to requirements or empirical values.

Alternatively, optionally, when the occurrence frequency of the candidate character sequence that satisfies the preset frequency condition is 1, the addition of the candidate character sequence to the preset code library is stopped, thereby stopping the update operation on the preset code library.

In this embodiment of the present disclosure, the preset code library including single code characters is generated, and the adjacent character sequence whose occurrence frequency in the five-stroke code corpus satisfies the preset frequency condition is introduced as the supplement to the single code characters and added to the preset code library, thereby enriching the code information in the preset code library and providing convenience for the subsequent determination of the code result of the training Chinese character based on the preset code library.

On the basis of the solutions described above, the present disclosure further provides an optional embodiment. In this optional embodiment, the construction process of the preset code library is described in detail. For the part that is not described in detail in this embodiment of the present disclosure, reference may be made to the related description of other embodiments.

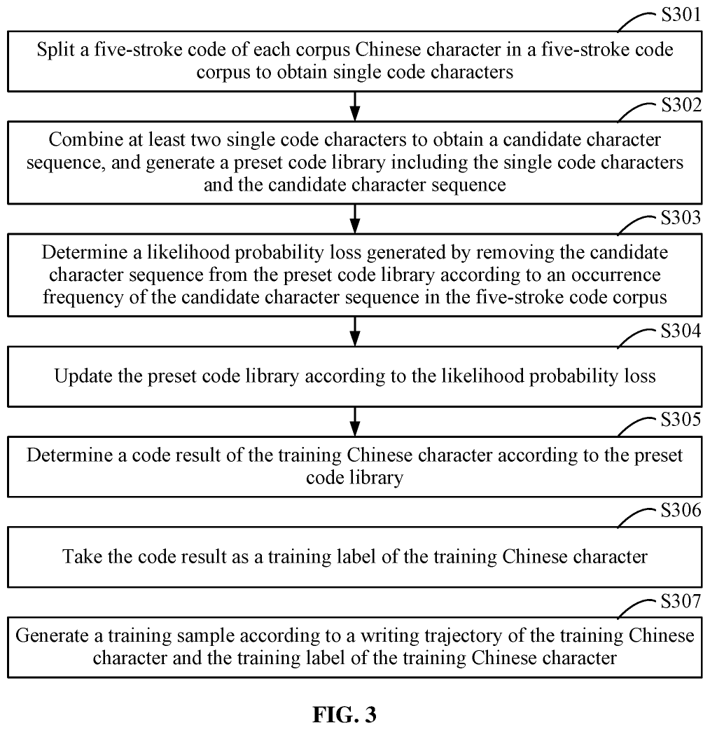

With reference to FIG. 3, the training sample generation method includes S301, S302, S303, S304, S305, S306 and S307.

In S301, a five-stroke code of each corpus Chinese character in a five-stroke code corpus is split to obtain single code characters.

In S302, at least two single code characters are combined to obtain a candidate character sequence, and a preset code library including the single code characters and the candidate character sequence is generated.

The preset code library is generated based on the single code characters and the candidate character sequence obtained by combining at least two single code characters, thereby improving the richness and diversity of the code information in the preset code library.

Since a large number of character pattern combinations which have poor universality or even do not occur exist in the candidate character sequence obtained by combining at least two single code characters, the preset code library generated according to the manner described above carries a large amount of invalid information, thereby affecting the determination efficiency for the determination of the code result of the training Chinese character based on the preset code library. Subsequently, the effectiveness and universality of the preset code library may be improved by performing the decrement processing on the candidate code characters in the preset code library.

In S303, a likelihood probability loss generated by removing the candidate character sequence from the preset code library is determined according to an occurrence frequency of the candidate character sequence in the five-stroke code corpus.

The likelihood probability loss is used for representing the importance of the removed candidate character sequence in the preset code library, thereby directly reflecting the universality of the removed candidate character sequence as a code character.

For example, a first likelihood probability generated when the candidate character sequence is not removed from the preset code library is determined, a second likelihood probability generated after the candidate character sequence is removed from the preset code library, and the likelihood probability loss is determined according to the difference between the first likelihood probability and the second likelihood probability. That is, a first likelihood probability of the preset code library is determined according to the occurrence frequency of the candidate character sequence in the five-stroke code corpus, a second likelihood probability of the preset code library after the candidate character sequence is removed is determined, and the difference between the first likelihood probability and the second likelihood probability is taken as the likelihood probability loss generated by removing the candidate character sequence from the preset code library.

The determination of the first likelihood probability and/or the second likelihood probability may be determined based on at least one method of the related art. For example, the determination of the first likelihood probability and/or the second likelihood probability may be performed based on an expectation-maximization (EM) algorithm.

It is to be understood that the difference in likelihood probabilities before and after one candidate character sequence is removed from the preset code library is taken as the likelihood probability loss to represent the importance and universality of the removed candidate character sequence in the subsequent encoding process. The solution described above improves the determination mechanism of the likelihood probability loss and provides the data support for the update of the preset code library.

Optionally, a reference probability of the candidate character sequence may be determined according to the occurrence frequency of the candidate character sequence in the five-stroke code corpus, and the maximum sum of reference probabilities of different candidate character sequences in the preset code library is taken as the first likelihood probability. The reference probability of the candidate character sequence is used for representing the possibility that the candidate character sequence occurs independently in the subsequent encoding process.

For example, the reference probability of the candidate character sequence may be determined according to the occurrence frequency of the candidate character sequence in the five-stroke code corpus and the occurrence frequency of each single code character obtained by splitting the candidate character sequence in the five-stroke code corpus.

The determination process of the reference probability is described below in detail using an example where the five-stroke code of Chinese character “ [symbol] ” is “je”. The candidate character sequence corresponding to Chinese character “ [symbol] ” is “je”, and the single code characters obtained by splitting the candidate character sequence are “j” and “e”. Accordingly, the reference probability of the candidate coded sequence “je” is: P′(je)=P(j)×P(e)+P(je), where P(*) represents the probability determined by the occurrence frequency of “*” in the five-stroke code corpus, and P′(*) represents the reference probability of “*”.

For example, a likelihood function is constructed based on reference probabilities of different candidate character sequences, and a function result corresponding the maximum function value of the likelihood function is taken as the first likelihood probability. For the convenience of calculation, the likelihood function may be constructed based on the sum of the reference probabilities of different candidate character sequences.

In the solution described above, the first likelihood probability is determined by introducing the reference probabilities and the maximum sum of the reference probabilities, thereby improving the determination mechanism of the first likelihood probability. The calculation in the manner described above is simple and quick, thereby improving the determination efficiency of the likelihood probability loss and further to improve the update efficiency of the preset code library.

It is to be noted that the determination process of the second likelihood probability is consistent with the determination process of the first likelihood probability. For example, after one candidate character sequence may be removed, the reference probabilities of other candidate character sequences may be determined according to the occurrence frequencies of the other candidate character sequences in the five-stroke code corpus, and the maximum sum of the reference probabilities of the other candidate character sequences in the preset code library is taken as the second likelihood probability. The reference probabilities of the other candidate character sequences are used for representing the possibilities that the other candidate character sequences occur independently in the subsequent encoding process.

For example, the reference probability of the candidate character sequence may be determined according to the occurrence frequencies of the other candidate character sequences in the five-stroke code corpus and the occurrence frequency of each single code character obtained by splitting the other candidate character sequences in the five-stroke code corpus; the likelihood function is constructed based on the reference probabilities of different other candidate character sequences, and the function result corresponding to the maximum function value of the likelihood function is taken as the second likelihood probability. For the convenience of calculation, the likelihood function may be constructed based on the sum of the reference probabilities of different candidate character sequences.

In S304, the preset code library is updated according to the likelihood probability loss.

For example, a candidate character sequence whose likelihood probability loss satisfies a preset loss condition is removed from the preset code library to update the preset code library. The preset loss condition may be determined by technicians according to requirements or empirical values or adjusted through a large number of trials.

Optionally, candidate character sequences whose likelihood probability loss is less than a preset loss threshold may be removed from the preset code library, and/or candidate character sequences whose number reaches a preset number threshold and whose likelihood probability loss is lower may be removed from the preset code library, thereby achieving the purpose of performing the decrement processing on the preset code library. The preset loss threshold and/or the preset number threshold may be determined by technicians according to requirements or empirical values or adjusted through a large number of trials.

It is to be understood that the candidate character sequences with poor universality or low importance in the preset code library are removed based on the likelihood probability loss, the occupation of the storage space of the preset code library can be significantly reduced, and the increase of the computation amount and the decrease of the calculation efficiency caused by invalid code characters (candidate character sequences with poor universality or low importance) in the encoding process can be avoided, thereby improving the generation efficiency of the training sample and reducing the computation amount.

For example, when the number of the code characters in the updated preset code library reaches a preset number threshold, the update of the preset code library may be stopped. The preset number threshold may be determined by technicians according to requirements or empirical values.

In S305, a code result of the training Chinese character is determined according to the preset code library.

In S306, the code result is taken as a training label of the training Chinese character.

In S307, a training sample is generated according to a writing trajectory of the training Chinese character and the training label of the training Chinese character.

In this embodiment of the present disclosure, the reserved single code character and the candidate code character obtained by combining at least two single code characters are generated, thereby achieving the construction of a full preset code library. Meanwhile, the likelihood probability loss is introduced so that the full preset code library is refined, the update manner of the preset code library is enriched and the existence of irreverent code information in the preset code library is avoided, thereby improving the rationality of the preset code library, reducing the computation amount and the calculation duration caused by the subsequent determination of the code result of the training Chinese character based on the preset code library, and proving convenience for the determination of the code result.

On the basis of the solutions described above, the present disclosure further provides an optional embodiment for implementing a trajectory recognition model training method. The trajectory recognition model training method provided by the present disclosure is suitable for the scenario where a trajectory recognition model for writing trajectory recognition is trained according to the training sample provided by the embodiments described above. The trajectory recognition model training method provided by the present disclosure can be executed by a trajectory recognition model training apparatus. The apparatus can be implemented by software and/or hardware and is specifically configured in an electronic device. It is to be noted that for the part that is not described in detail in the present disclosure, reference may be made to the related description of other embodiments.

It is to be noted that the electronic device performing the trajectory recognition model training method and the electronic device performing the training sample generation method may be the same or different and is not limited to the present disclosure.

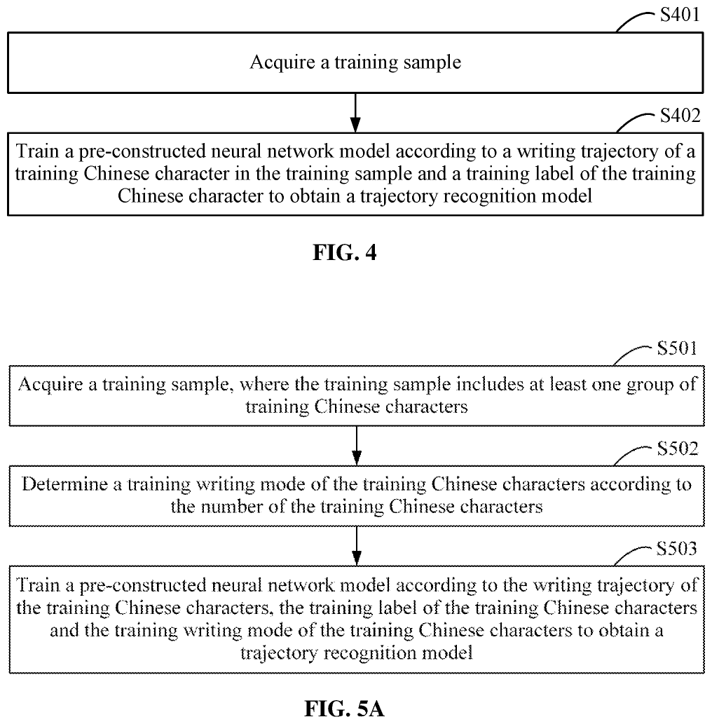

With reference to FIG. 4, the trajectory recognition model training method includes S401 and S402.

In S401, a training sample is acquired.

The training sample is obtained based on any training sample generation method provided by the embodiments of the present disclosure.

The training sample may be pre-stored locally in the electronic device performing the trajectory recognition model training method, or stored in other storage devices or clouds associated with the electronic device and is acquired when needed, and the present disclosure does not limit the specific acquisition position of the training sample.

The number of training samples may be at least one, and in order to ensure the performance of the trained model, the number of training samples may usually be multiple. The specific number may be determined by technicians according to requirements or empirical values or adjusted according to the training and is not limited to the present disclosure.

In S402, a pre-constructed neural network model is trained according to a writing trajectory of a training Chinese character in the training sample and a training label of the training Chinese character to obtain a trajectory recognition model.

For example, the handwriting estimation of the training Chinese character and the training label of the training Chinese character are inputted into the pre-constructed neural network model to optimize the network parameters in the neural network model, and the neural network model obtained when a training cut-off condition is satisfied is taken as the trajectory recognition model for the subsequent recognition of the code result corresponding to the writing trajectory. The training cut-off condition may be at least one of the following conditions: the number of training samples reaches a preset number threshold, the precision of the trained model reaches a preset precision threshold, and the trained model tends to be stationary. The preset number threshold and the preset precision threshold may be set or adjusted by the technicians according to requirements or empirical values.

The pre-constructed neural network model may be obtained based on the combination of at least one machine learning model or deep learning model in the related art, and the present disclosure does not limit the specific network structure of the pre-constructed neural network model.

It is to be noted that since different users have different writing habits, for example, some users are used to single-character writing while some users are used to multi-character overlapping writing or multi-character continuous writing, training Chinese characters may be divided according to writing habits, and corresponding neural network models may be trained using training Chinese characters corresponding to different writing habits to obtain trajectory recognition models adapted to corresponding writing habits. It is to be understood that in order to distinguish the code results of different training Chinese characters, a label start character may be added before the code result corresponding to each single Chinese character. For example, if a group of training Chinese characters is “ [symbol] ”, the corresponding training label is “_je_gd”, where “_” is the label start character. Accordingly, when the code result is predicted using the trajectory recognition model, whether the label start character exists in the code prediction result is determined to determine whether the prediction result corresponds to one Chinese character. It is to be understood that after the label start character is added, the results before and after the same code character is added with the label initial character may be considered as different code units. For example, the training label corresponding to Chinese character “ [symbol] ” is “_je”, the training label corresponding to Chinese character “ [symbol] ” is “_ej”, “j” and “j” are different code units, and “_e” and “e” are also different code units.

In the present disclosure, a training label carrying the stroke information and character pattern information and a writing trajectory carrying the content information and position information are introduced to train a pre-constructed neural network model so that the trained trajectory recognition model has the capability to predict corresponding code results based on the writing trajectory of Chinese characters. Since the training label has the stroke information and character pattern information during model training, the implicit relationship (such as the character pattern, semantics and grammar and the like) between different trained Chinese characters may be fully considered in the model training process, and no semantic model is required to explore the implicit relationship, thereby reducing the number of model parameters and the computation amount and avoiding the problem of out-of-vocabulary (OOV) words caused by the inability to enumerate all Chinese characters.

On the basis of the solutions described above, the embodiments of the present disclosure further provide an optional embodiment. In this embodiment, the generation process of the trajectory recognition model is described in detail. It is to be noted that for the part that is not described in detail in the present disclosure, reference may be made to the related description of other embodiments.

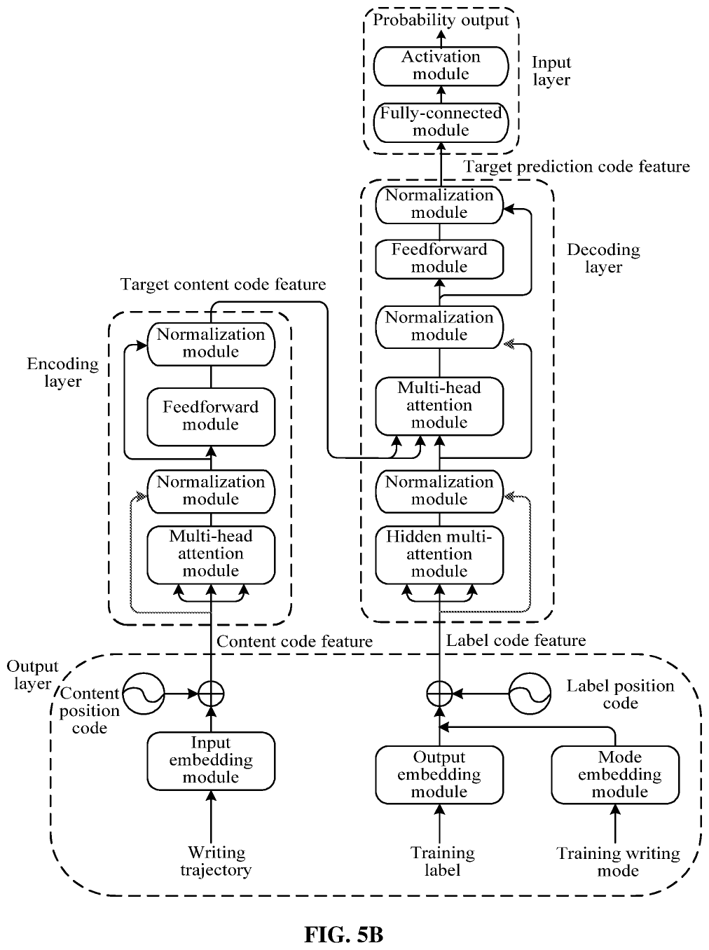

With reference to FIG. 5A, the trajectory recognition model training method includes S501, S502 and S503.

In S501, a training sample is acquired, where the training sample includes at least one group of training Chinese character.

The number of Chinese characters in each group of training Chinese character is the same or different.

In S502, a training writing mode of each training Chinese character is determined according to the number of at least one training Chinese character.

The training writing mode is used for representing the writing mode used when the writing trajectory of the training Chinese character is generated. The writing mode may include a single-character writing mode, that is, the writing trajectory of only one Chinese character may be generated at a single time, that is, one group of training Chinese character only includes one Chinese character. The writing mode may include a multi-character writing mode, that is, the writing trajectories of at least one Chinese character may be generated at a single time, that is, one group of training Chinese character may include at least one Chinese character. In the multi-character writing mode, continuous writing or overlapping writing may be adopted to generate the writing trajectories of at least one Chinese character, and the present disclosure does not limit the specific writing mode in the multi-character writing mode.

For example, the training writing mode corresponding to the training Chinese character is determined to be the multi-character writing mode or the single-character writing mode according to the number of training Chinses characters.

In a specific embodiment, if the number of Chinese characters is greater than 1, the training writing mode of the training Chinese characters is determined to be the multi-character writing mode; and if the number of Chinese characters is equal to 1, the training writing mode of the training Chinese character is randomly determined to be the multi-character writing mode or the single-character writing mode. The advantage of such a setting is that the training writing mode can be automatically determined, thereby reducing the time cost and labor cost.

In S503, a pre-constructed neural network model is trained according to the writing trajectory of the training Chinese characters, the training label of the training Chinese characters and the training writing mode of the training Chinese characters to obtain a trajectory recognition model.

It is to be noted that in order to distinguish the writing trajectories of different groups of training Chinese characters, a preset start character may be added at the start position of the same group of training Chinese characters, and a preset stop character may be added at the end position.

It is to be understood that the training writing mode is introduced for model training so that in the model training process, the correspondence between the writing trajectories in different modes and the training labels is learned, and in this manner, the trained trajectory recognition model can distinguish the writing trajectories in different writing modes and obtain the ability to distinguish different writing modes, thereby improving the adaptability of the trained model to different writing modes.

For example, the training label of the training Chinese character may be updated according to the training writing mode of the training Chinese character, and the pre-constructed neural network model is trained according to the writing trajectory of the training Chinese character and the updated training label to obtain the trajectory recognition model.

In an optional embodiment, a label code feature of the training Chinese character may be determined according to the training writing mode of the training Chinese character and the training label of the training Chinese character, and the pre-constructed neural network model is trained according to the label code feature of the training Chinese character and a content code feature corresponding to the writing trajectory of the training Chinese character.

The label code feature is used for representing the feature data carried by the theoretical output result corresponding to the training Chinese character, and the content code feature is used for representing the feature data carried by the writing trajectory of the training Chinese character.

It is to be noted that the present disclosure does not limit the specific determination manner of the label code feature and the content code feature, and the determination of the label code feature and the content code feature can be achieved adopting at least one encoding module in the related art, for example, feature extraction may be performed using a preset number of convolution layers, and the feature extraction result may be taken as the corresponding code feature.

In the present disclosure, the content code feature and the label code feature are introduced to perform model training, and the mapping relationship between the content code feature and the label code feature is established so that the trained trajectory recognition model obtained can perform corresponding label recognition on unknown Chinese character writing trajectories under different writing modes based on the mapping relationship. The advantage of such a setting is that the existing encoding module can be reused to extract the label code feature and the content code feature, respectively, and then the neural network model is trained directly according to the label code feature and the content code feature, thereby reducing the number of trained model parameters and improving the model training efficiency.

In an optional embodiment, the step in which the label code feature of the training Chinese character is determined according to the training writing mode of the training Chinese character and the training label of the training Chinese character may be: the training label of the training Chinese character is encoded to obtain an initial code feature of the training Chinese character, the training writing mode of the training Chinese character is encoded to obtain a mode code feature of the training Chinese character, and feature fusion is performed on the initial code feature of the training Chinese character and the mode code feature of the training Chinese character to obtain the label code feature of the trained Chinese character.

Since the initial code feature is obtained by encoding the training label, the label code feature carries the stroke information and the character pattern information; since the mode code feature is obtained by encoding the training writing mode, the mode code feature carries the writing mode information; the initial code feature of the training Chinese character is fused with the mode code feature of the training Chinese character to obtain the label code feature so that the richness and diversity of the content of the label code feature are improved, thereby improving the model training efficiency and the model precision of the trained model.

The model training process is described in detail below with reference to the structural diagram of the neural network model shown in FIG. 5B.

For example, the neural network model includes an input layer, an encoding layer, a decoding layer and an output layer.

In an optional embodiment, the input layer includes an input embedding module, an input fusion module, an output embedding module, a mode embedding module and an output fusion module.

For example, the input embedding module is configured to encode the writing trajectory of the training Chinese character to obtain a trajectory code result, and the input fusion module is configured to fuse the trajectory code result with a content position code of the writing trajectory to obtain the content code feature. The content position code may be obtained by encoding the writing trajectory using sine and cosine positional encoding.

For example, the output embedding module is configured to encode the training label of the training Chinese character to obtain the initial code feature, the mode embedding module is configured to encode the training writing mode of the training Chinese character to obtain the mode code feature, and the output fusion module is configured to fuse the initial code feature, the label position code and the mode code feature to obtain a label code feature. The label position code may be obtained by encoding the training label using sine and cosine positional encoding.

In an optional embodiment, the encoding layer may include a multi-head attention module, a feedforward module and a normalization module.

For example, the multi-head attention module is configured to perform global context fusion on the content code feature to obtain a global content code feature, thereby improving the richness and diversity of the information carried by the code feature.

For example, the feedforward module is configured to perform non-linearly processing on the inputted global content code feature to obtain a target content code feature to increase the non-linearity feature.

For example, the normalization module is configured to perform residual normalization processing on the input data to update the input data, so as to accelerate model convergence, thereby improving the overall stability of the model and preventing model degradation. The input data may be the global content code feature outputted by the multi-head attention module or the target content code feature outputted by the feedforward module.

In an optional embodiment, the decoding layer may include a hidden multi-attention module, a multi-attention module, a feedforward module and a normalization module.

For example, the hidden multi-head attention module is configured to perform global context fusion on the label code feature to obtain a target label code feature, thereby enriching the information carried by the label code feature. In this module, a mask is added on the basis of the multi-head attention module so that part of the data is masked in the processing process so that no effect is produced when its parameters are updated. It is to be noted that each time step of the hidden multi-head attention module fuses the character information of the previous time steps, and the grammatical relationship is effectively modeled, thereby further enriching the amount of the information carried in the target label code feature.

For example, the multi-head attention module is configured to extract a prediction code feature associated with the target label code feature in the target content code feature outputted by the encoding layer.

For example, the feedforward module is configured to preform non-linearly processing on the input data to obtain a target prediction code feature to increase the non-linearity feature.

For example, the normalization module is configured to perform residual normalization processing on the input data to update the input data, so as to accelerate model convergence, thereby improving the overall stability of the model and preventing model degradation. The input data may be the target label code feature outputted by the hidden multi-head attention module, the prediction code feature outputted by the multi-head attention module or the target prediction code feature outputted by the feedforward module.

In an optional embodiment, the output layer may include a fully-connected module and an activation module.

For example, the fully-connected module is configured to perform linear transformation once on the target prediction code feature so that the sample feature in the handwriting trajectory is provided with a training label and a sample label space corresponding to the training writing mode.

For example, the activation module is configured to activate the output result of the fully-connected module to map the value of the output result to 0-1, so as to obtain a probability output, and take the code result corresponding to the maximum probability output as a prediction output through the preset code library.

It is to be understood that since the model structure described above may perform parallel computing during encoding, no timing cycle exists; during decoding, the syntax relationship between characters is effectively established, and no additional language model is required to be accessed to, thereby effectively reducing the resource consumption and delay. Meanwhile, the training label is generated based on the code result of the five-stroke code corpus so that the differences and connections between different Chinese characters can be reflected and the code length of the training label can be reduced, thereby greatly reducing the number of model parameters and the computation amount, reducing the computing power requirements for the training device and the subsequent trajectory recognition device and effectively avoiding the OOV problem. Further, the training writing mode is introduced in the training stage so that the difference between different writing modes is effectively established, the model can adaptively output different results according to different mode settings, manual empirical values are eliminated, and the accuracy and the universality become higher.

It is to be noted that the model structure described above is only used for illustrating the preset neural network model and should not be construed as the limitation to the specific network structure of the neural network model.

On the basis of the solutions described above, the present disclosure further provides an optional embodiment for implementing a trajectory recognition method. The trajectory recognition method provided by the present disclosure is suitable for the scenario where a trajectory is recognized according to the trajectory recognition model provided by the embodiments described above. The trajectory recognition method provided by the present disclosure can be executed by a trajectory recognition apparatus. The apparatus can be implemented by software and/or hardware and is specifically configured in an electronic device. It is to be noted that for the part that is not described in detail in the present disclosure, reference may be made to the related description of other embodiments.

It is to be noted that the electronic device performing the trajectory recognition model training method, the electronic device performing the training sample generation method and the electronic device performing the trajectory recognition method may be the same or at least partially different and is not limited to the present disclosure.

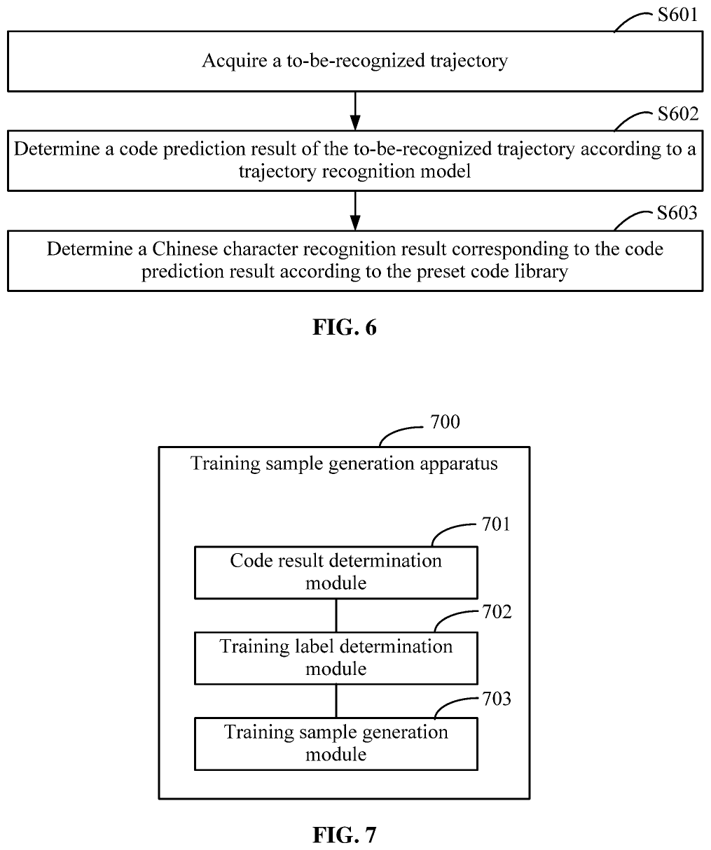

With reference to FIG. 6, the trajectory recognition method includes S601, S602 and S603.

In S601, a to-be-recognized trajectory is acquired.

Since only Chinese characters have five-stroke codes, the to-be-recognized trajectory in the present disclosure is a writing trajectory generated when Chinese characters are written.

Optionally, the to-be-recognized trajectory may be pre-stored in the electronic device locally or in other storage devices and is acquired when trajectory recognition is needed to be performed; or optionally, when a Chinese character is inputted in the user terminal, the writing trajectory of the inputted Chinese character is collected in real-time as the to-be-recognized trajectory; or optionally, a writing trajectory carried in a carrier such as a picture is extracted as the to-be-recognized trajectory. The to-be-recognized trajectory may be generated by writing a single Chinese character or by writing at least one Chinese character in a continuous or overlapping writing manner, and the present disclosure does not limit the generation manner of the to-be-recognized trajectory.

In S602, a code prediction result of the to-be-recognized trajectory is determined according to a trajectory recognition model.

The trajectory recognition model is obtained based on any trajectory recognition model training method provided by the embodiments of the present disclosure.

The to-be-recognized trajectory may be inputted into the trajectory recognition model to obtain the code prediction result of the to-be-recognized trajectory.

In an optional embodiment, if different trajectory recognition models are trained for different writing modes, a corresponding trajectory recognition model may be selected according to the writing mode when the to-be-recognized trajectory is generated, and the to-be-recognized trajectory is inputted into the corresponding trajectory recognition model to obtain the code prediction result of the to-be-recognized trajectory.

In another optional embodiment, if the trajectory recognition model is trained using training samples under different training writing modes, a prediction writing mode of the to-be-recognized trajectory may also be obtained; and accordingly, the step in which the code prediction result of the to-be-recognized trajectory is determined according to the trajectory recognition model may be: based on the trajectory recognition model, the code prediction result of the to-be-recognized trajectory is determined according to the to-be-recognized trajectory and the prediction writing mode.

The prediction writing mode may be understood as the writing model used when the to-be-recognized trajectory is generated and may be the single-character writing mode or the multi-character writing mode.

It is to be understood that the code prediction is performed using a trajectory recognition model obtained through mixed training under different training writing modes, and the prediction writing mode of the to-be-recognized trajectory is introduced in the code prediction process so that the selection of the trajectory recognition model under different writing modes is not required, thereby reducing the number of models to be trained and the cost of model storage and improving the user experience.

For example, if the prediction writing mode is the single-character writing mode, the to-be-recognized trajectory is inputted into the trajectory recognition model, and the code prediction result is outputted.

For example, if the prediction writing mode is the multi-character writing mode, a preset start character and a recognized code prediction result are taken as a prediction label, and the prediction label and the to-be-recognized trajectory are inputted into the trajectory recognition model to obtain a code prediction result of current recognition, where a recognized code prediction result corresponding to initial recognition is null.

Since in the multi-character writing mode, the code results of Chinese characters written later are predicted according to the character pattern information and semantics information of the corresponding trajectories of previously written Chinese characters, the code prediction results corresponding to different written Chinese characters are determined in sequence according to the writing order, and the previous code prediction results are taken as the basis for determining the latter code prediction results, thereby improving the accuracy of the code prediction result in the multi-character writing mode and providing convenience for the determination of the subsequent Chinese character recognition result word by word.

For example, if the prediction writing mode is the multi-character writing mode, when the code prediction result of the current recognition is a preset stop character, the code prediction result of the to-be-recognized trajectory may be stopped to be determined, and the prediction of the code result corresponding to the whole group of Chinese characters in the to-be-recognized trajectory may be ended. It is to be understood that in the solution described above, the preset stop character is introduced to determine the trigger time of stopping the code result prediction, thereby avoiding the waste of computation resources.

In S603, a Chinese character recognition result corresponding to the code prediction result is determined according to the preset code library.

The stroke pattern corresponding to the code prediction result is searched from the preset code library to obtain the Chinese character recognition result corresponding to the code prediction result.

If the code prediction result includes code prediction results of at least two Chinese characters, the Chinese character recognition result corresponding to each code prediction result may be determined in sequence according to the prediction order.

For the generation manner of the preset code library, reference may be made to the related description of the embodiments described above.

It is to be noted that if a label start character is added to the training label used in the trajectory recognition model training stage, a label start character is also added before the first predicted code unit of a single Chinese character when the coding prediction result is determined. Accordingly, when the Chinese character recognition result is determined, the Chinese character is independently divided through the label start character, thereby improving the accuracy of the Chinese character recognition result.

In this embodiment of the present disclosure, the code prediction result of the trajectory to-be-recognized is determined based on the trajectory recognition model provided by the embodiments described above, thereby improving the determination efficiency and accuracy of the code prediction result. Accordingly, the Chinese character recognition result corresponding to the code prediction result is determined according to the preset code library, thereby improving the recognition efficiency and accuracy of the Chinese character recognition result and improving the accuracy of the recognition result of rarely-used Chinese characters.

As the implementation of the training sample generation method described above, the present disclosure further provides an optional embodiment of an apparatus for performing the training sample generation method. Further, with reference to FIG. 7, a training sample generation apparatus 700 includes a code result determination module 701, a training label determination module 702 and a training sample generation module 703.

The code result determination module 701 is configured to determine a code result of a training Chinese character according to a preset code library, where the preset code library is generated based on code characters in a five-stroke code corpus.

The training label determination module 702 is configured to take the code result as a training label of the training Chinese character.

The training sample generation module 703 is configured to generate a training sample according to a writing trajectory of the training Chinese character and the training label of the training Chinese character.

Since the writing trajectory of the training Chinese character carries the content information and the position information and the training label carries stroke information and character pattern information, the training sample is generated according to the writing trajectory of the training Chinese character and the training label of the training Chinese character, thereby improving the richness of the information carried in the training sample. Accordingly, when the subsequent trajectory recognition model is trained based on the training sample, the precision of the trajectory recognition model is improved so that the accuracy of the trajectory recognition result obtained when the trajectory recognition model is used is improved.

In an optional embodiment, the apparatus further includes a five-stroke code split module, a preset code library construction module and a preset code library update module.

The five-stroke code split module is configured to split a five-stroke code of each corpus Chinese character in the five-stroke code corpus.

The preset code library construction module is configured to construct a preset code library according to a split result.

The preset code library update module is configured to update the preset code library according to an occurrence frequency of a candidate character sequence in the five-stroke code corpus.

The candidate character sequence consists of at least two single code characters.

In an optional embodiment, the split result includes a single code character and an adjacent character sequence.

The preset code library construction module includes a first preset code library generation unit.

The first preset code library generation unit is configured to generate a preset code library including each single code character.

The preset code library update module includes a first candidate character sequence determination unit and a first preset code library update unit.

The first candidate character sequence determination unit is configured to take the adjacent character sequence as the candidate character sequence.

The first preset code library update unit is configured to add a candidate character sequence whose occurrence frequency in the five-stroke code corpus satisfies a preset frequency condition to the preset code library to update the preset code library.

In an optional embodiment, the split result includes a single code character.

The preset code library construction module includes a second candidate character sequence generation unit and a second preset code library generation unit.

The second candidate character sequence generation unit is configured to combine at least two single code characters to obtain the candidate character sequence.

The second preset code library generation unit is configured to generate a preset code library including the single code character and the candidate character sequence.

The preset code library update module includes a likelihood probability loss generation unit and a second preset code library update unit.

The likelihood probability loss generation unit is configured to determine a likelihood probability loss generated by removing the candidate character sequence from the preset code library according to the occurrence frequency of the candidate character sequence in the five-stroke code corpus.

The second preset code library update unit is configured to update the preset code library according to the likelihood probability loss.

In an optional embodiment, the likelihood probability loss generation unit includes a first likelihood probability determination sub-unit, a second likelihood probability determination sub-unit and a likelihood probability loss generation sub-unit.

The first likelihood probability determination sub-unit is configured to determine a first likelihood probability of the preset code library according to the occurrence frequency of the candidate character sequence in the five-stroke code corpus.

The second likelihood probability determination sub-unit is configured to determine a second likelihood probability of the preset code library after the candidate character sequence is removed.

The likelihood probability loss generation sub-unit is configured to take a difference between the first likelihood probability and the second likelihood probability as the likelihood probability loss generated by the candidate character sequence.

In an optional embodiment, the first likelihood probability determination sub-unit includes a reference probability determination slave unit and a first likelihood probability determination slave unit.

The reference probability determination slave unit is configured to determine a reference probability of the candidate character sequence according to the occurrence frequency of the candidate character sequence in the five-stroke code corpus. The first likelihood probability determination slave unit is configured to take a maximum sum of reference probabilities of different candidate character sequences in the preset code library as the first likelihood probability.

In an optional embodiment, the second preset code library update unit includes a second preset code library update sub-unit.

The second preset code library update sub-unit is configured to remove a candidate character sequence whose likelihood probability loss satisfies a preset loss condition from the preset code library to update the preset code library.

The training sample generation apparatus described above may perform the training sample generation method provided by any embodiment of the present disclosure and has functional modules and beneficial effects corresponding to the performed training sample generation method.

As the implementation of the trajectory recognition model training method described above, the present disclosure further provides an optional embodiment of an apparatus for performing the trajectory recognition model training method. Further, with reference to FIG. 8, a trajectory recognition model training apparatus 800 includes a training sample acquisition module 801 and a trajectory recognition model training module 802.

The training sample acquisition module 801 is configured to acquire a training sample, where the training sample is obtained based on any training sample generation method provided by the embodiments of the present disclosure.

The trajectory recognition model training module 802 is configured to train a pre-constructed neural network model according to a writing trajectory of a training Chinese character in the training sample and a training label of the training Chinese character to obtain a trajectory recognition model.

In the present disclosure, a training label carrying the stroke information and character pattern information and a writing trajectory carrying the content information and position information are introduced to train a pre-constructed neural network model so that the trained trajectory recognition model has the capability to predict corresponding code results based on the writing trajectory of Chinese characters. Since the training label has the stroke information and character pattern information during model training, the implicit relationship (such as the character pattern, semantics and grammar and the like) between different trained Chinese characters may be fully considered in the model training process, and no semantic model is required to explore the implicit relationship, thereby reducing the number of model parameters and the computation amount and avoiding the problem of OOV words caused by the inability to enumerate all Chinese characters.

In an optional embodiment, the trajectory recognition model training module 802 includes a training writing mode determination unit and a trajectory recognition model training unit.

The training writing mode determination unit is configured to determine a training writing mode of the training Chinese characters according to the number of Chinese characters in the training Chinese character.

The trajectory recognition model training unit is configured to train the pre-constructed neural network model according to the writing trajectory of the training Chinese character, the training label of the training Chinese character and the training writing mode of the training Chinese character.

In an optional embodiment, the trajectory recognition model training unit 802 includes a label code feature determination sub-unit and a trajectory recognition model training sub-unit.

The label code feature determination sub-unit is configured to determine a label code feature of the training Chinese character according to the training writing mode of the training Chinese character and the training label of the training Chinese character.

The trajectory recognition model training sub-unit is configured to train the pre-constructed neural network model according to the label code feature of the training Chinese character and a content code feature corresponding to the writing trajectory of the training Chinese character.

In an optional embodiment, the label code feature determination sub-unit includes an initial code feature obtaining slave unit, a mode code feature obtaining slave unit and a label code feature determination slave unit.

The initial code feature obtaining slave unit is configured to encode the training label of the training Chinese character to obtain an initial code feature of the training Chinese character.

The mode code feature obtaining slave unit is configured to encode the training writing mode of the training Chinese character to obtain a mode code feature of the training Chinese character.

The label code feature determination slave unit is configured to perform feature fusion on the initial code feature of the training Chinese character and the mode code feature of the training Chinese character to obtain the label code feature of the training Chinese character.

In an optional embodiment, the training writing mode determination unit includes a first training writing mode determination sub-unit and a second training writing mode determination sub-unit.

The first training writing mode determination sub-unit is configured to, if the number of Chinese characters is greater than 1, determine the training writing mode of the training Chinese characters to be a multi-character writing mode.

The second training writing mode determination sub-unit is configured to, if the number of Chinese characters is equal to 1, randomly determine the training writing mode of the training Chinese character to be a multi-character writing mode or a single-character writing mode.

The trajectory recognition model training apparatus described above may perform the trajectory recognition model training method provided by any embodiment of the present disclosure and has functional modules and beneficial effects corresponding to the performed trajectory recognition model training method.

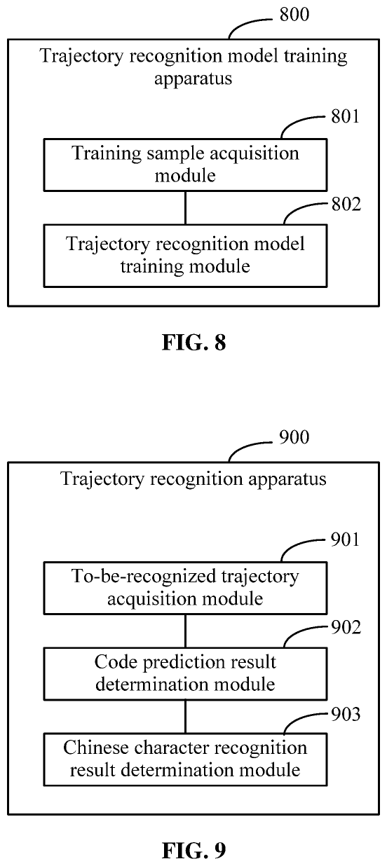

As the implementation of the trajectory recognition method described above, the present disclosure further provides an optional embodiment of an apparatus for performing the trajectory recognition method. Further, with reference to FIG. 9, a trajectory recognition apparatus 900 includes a to-be-recognized trajectory acquisition module 901, a code prediction result determination module 902 and a Chinese character recognition result determination module 903.

The to-be-recognized trajectory acquisition module 901 is configured to acquire a to-be-recognized trajectory.

The code prediction result determination module 902 is configured to determine a code prediction result of the to-be-recognized trajectory according to a trajectory recognition model, where the trajectory recognition model is obtained based on the above trajectory recognition model training apparatus.

The Chinese character recognition result determination module 903 is configured to determine a Chinese character recognition result corresponding to the code prediction result according to the preset code library.

In this embodiment of the present disclosure, the code prediction result of the trajectory to-be-recognized is determined based on the trajectory recognition model provided by the embodiments described above, thereby improving the determination efficiency and accuracy of the code prediction result. Accordingly, the Chinese character recognition result corresponding to the code prediction result is determined according to the preset code library, thereby improving the recognition efficiency and accuracy of the Chinese character recognition result and improving the accuracy of the recognition result of rarely-used Chinese characters.

In an optional embodiment, the apparatus further includes a prediction writing mode acquisition module.

The prediction writing mode acquisition module is configured to acquire a prediction writing mode of the to-be-recognized trajectory.

The code prediction result determination module includes a code prediction result determination unit.

The code prediction result determination unit is configured to determine the code prediction result of the to-be-recognized trajectory according to the to-be-recognized trajectory and the predicted writing mode based on the trajectory recognition model.

In an optional embodiment, the code prediction result determination unit includes a prediction label determination sub-unit and a code prediction result determination sub-unit.

The prediction label determination sub-unit is configured to, if the prediction writing mode is a multi-character writing mode, take a preset start character and a recognized code prediction result as a prediction label.

The code prediction result determination sub-unit is configured to input the prediction label and the to-be-recognized trajectory into the trajectory recognition model to obtain a code prediction result of current recognition.

The recognized code prediction result corresponding to initial recognition is null.

In an optional embodiment, the code prediction result determination unit further includes a determination stop sub-unit.

The determination stop sub-unit is configured to, if the code prediction result of the current recognition is a preset stop character, stop determining the code prediction result of the to-be-recognized trajectory.

The trajectory recognition apparatus described above may perform the trajectory recognition method provided by any embodiment of the present disclosure and has functional modules and beneficial effects corresponding to the performed trajectory recognition method.

In the solutions of the present disclosure, the collection, storage, use, processing, transmission, provision and disclosure of the writing trajectory of the training Chinese character and the to-be-recognized trajectory involved herein are in compliance with provisions of relevant laws and regulations and do not violate public order and good customs.

According to an embodiment of the present disclosure, the present disclosure further provides an electronic device, a readable storage medium and a computer program product.

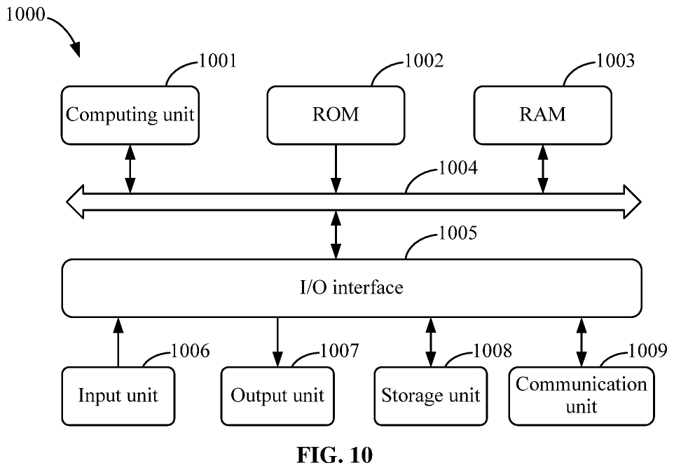

FIG. 10 is an exemplary block diagram of an example electronic device 1000 that may be used for performing the embodiments of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present application as described and/or claimed herein.

As shown in FIG. 10, the device 1000 includes a computing unit 1001. The computing unit 1001 may perform various types of appropriate operations and processing based on a computer program stored in a read-only memory (ROM) 1002 or a computer program loaded from a storage unit 1008 to a random-access memory (RAM) 1003. Various programs and data required for the operation of the device 1000 may also be stored in the RAM 1003. The computing unit 1001, the ROM 1002 and the RAM 1003 are connected to each other via a bus 1004. An input/output (I/O) interface 1005 is also connected to the bus 1004.

Multiple components in the device 1000 are connected to the I/O interface 1005. The multiple components include an input unit 1006 such as a keyboard or a mouse, an output unit 1007 such as various types of displays or speakers, the storage unit 1008 such as a magnetic disk or an optical disc, and a communication unit 1009 such as a network card, a modem or a wireless communication transceiver. The communication unit 1009 allows the device 1000 to exchange information/data with other devices over a computer network such as the Internet and/or various telecommunications networks.

The computing unit 1001 may be various general-purpose and/or special-purpose processing components having processing and computing capabilities. Some examples of the computing unit 1001 include, but are not limited to, central processing units (CPUs), graphics processing units (GPUs), various special-purpose artificial intelligence (AI) computing chips, various computing units running machine learning models and algorithms, digital signal processors (DSPs), and any suitable processors, controllers and microcontrollers. The computing unit 1001 performs various methods and processing described above, such as at least one of the training sample generation method, the trajectory recognition model training method or the trajectory recognition method. For example, in some embodiments, at least one of the training sample generation method, the trajectory recognition model training method or the trajectory recognition method may be implemented as a computer software program tangibly contained in a machine-readable medium such as the storage unit 1008. In some embodiments, part or all of computer programs may be loaded and/or installed on the device 1000 via the ROM 1002 and/or the communication unit 1009. When the computer programs are loaded into the RAM 1003 and performed by the computing unit 1001, one or more steps of the method described above (at least one of the training sample generation method, the trajectory recognition model training method or the trajectory recognition method) may be performed. Alternatively, in other embodiments, the computing unit 1001 may be configured, in any other suitable manner (for example, by means of firmware), to perform at least one of the training sample generation method, the trajectory recognition model training method or the trajectory recognition method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Program codes for implementation of the methods of the present disclosure may be written in one programming language or any combination of multiple programming languages. The program codes may be provided for the processor or controller of a general-purpose computer, a special-purpose computer or another programmable data processing apparatus to enable functions/operations specified in flowcharts and/or block diagrams to be implemented when the program codes are executed by the processor or controller. The program codes may be executed entirely on a machine or may be executed partly on a machine. As a stand-alone software package, the program codes may be executed partly on a machine and partly on a remote machine or may be executed entirely on a remote machine or a server.

In the context of the present disclosure, the machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a blockchain.

Artificial intelligence is the study of making computers simulate certain human thinking processes and intelligent behaviors (such as learning, reasoning, thinking and planning), including technologies at both the hardware and software levels. Artificial intelligence hardware technologies generally include technologies such as sensors, special-purpose artificial intelligence chips, cloud computing, distributed storage and big data processing. Artificial intelligence software technologies mainly include several major technologies such as computer vision technologies, speech recognition technologies, natural language processing technologies, machine learning/deep learning technologies, big data processing technologies and knowledge mapping technologies.

It is to be understood that various forms of the preceding flows may be used with steps reordered, added, or removed. For example, the steps described in the present disclosure may be executed in parallel, in sequence, or in a different order as long as the desired result of the technical solutions provided in the present disclosure is achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A training sample generation method, comprising:
determining a code result of a training Chinese character according to a preset code library; wherein the preset code library is generated based on code characters in a five-stroke code corpus;
taking the code result as a training label of the training Chinese character; and
generating a training sample according to both a writing trajectory and a training label of the training Chinese character.

2. The method according to claim 1, further comprising:
splitting a five-stroke code of each of a plurality of corpus Chinese characters in the five-stroke code corpus to obtain a respective one of a plurality of split results;
constructing a preset code library according to the plurality of split results; and
updating the preset code library according to an occurrence frequency of a candidate character sequence in the five-stroke code corpus;
wherein the candidate character sequence consists of at least two single code characters.

3. The method according to claim 2, wherein
each of the plurality of split results comprises a respective one of a plurality of single code characters and a respective one of a plurality of adjacent character sequences;
the constructing a preset code library according to the plurality of split results comprises: generating a preset code library comprising the plurality of single code characters; and
the updating the preset code library according to an occurrence frequency of a candidate character sequence in the five-stroke code corpus comprises: taking each of the plurality of adjacent character sequences as the candidate character sequence; and adding a candidate character sequence whose occurrence frequency in the five-stroke code corpus satisfies a preset frequency condition to the preset code library to update the preset code library.

4. The method according to claim 2, wherein
each of the plurality of split results comprises a respective one of a plurality of single code characters;
the constructing a preset code library according to the plurality of split results comprises: combining at least two of the plurality of single code characters to obtain the candidate character sequence, and generating a preset code library comprising the plurality of single code characters and the candidate character sequence; and
the updating the preset code library according to an occurrence frequency of a candidate character sequence in the five-stroke code corpus comprises: determining a likelihood probability loss generated by removing the candidate character sequence from the preset code library according to the occurrence frequency of the candidate character sequence in the five-stroke code corpus; and updating the preset code library according to the likelihood probability loss.

5. The method according to claim 4, wherein the determining a likelihood probability loss generated by removing the candidate character sequence from the preset code library according to the occurrence frequency of the candidate character sequence in the five-stroke code corpus comprises:
determining a first likelihood probability of the preset code library according to the occurrence frequency of the candidate character sequence in the five-stroke code corpus;
determining a second likelihood probability of a preset code library from which the candidate character sequence is removed; and
taking a difference between the first likelihood probability and the second likelihood probability as the likelihood probability loss generated by removing the candidate character sequence from the preset code library.

6. The method according to claim 5, wherein the determining a first likelihood probability of the preset code library according to the occurrence frequency of the candidate character sequence in the five-stroke code corpus comprises:
determining a reference probability of the candidate character sequence according to the occurrence frequency of the candidate character sequence in the five-stroke code corpus;
constructing a likelihood function based on reference probabilities of different candidate character sequences in the five-stroke code corpus; and
taking a maximum of the likelihood function as the first likelihood probability.

7. The method according to claim 4, wherein the updating the preset code library according to the likelihood probability loss comprises:
updating the preset code library by removing a candidate character sequence whose likelihood probability loss satisfies a preset loss condition from the preset code library.

8. A trajectory recognition model training method, comprising:
acquiring a training sample; and
training a pre-constructed neural network model according to both a writing trajectory and a training label of each of at least one training Chinese character in the training sample to obtain a trajectory recognition model;
wherein the training sample is obtained by the followings:
determining a code result of a training Chinese character according to a preset code library; wherein the preset code library is generated based on code characters in a five-stroke code corpus;
taking the code result as a training label of the training Chinese character; and
generating a training sample according to both a writing trajectory and a training label of the training Chinese character.

9. The method according to claim 8, wherein the training a pre-constructed neural network model according to both a writing trajectory and a training label of each of at least one training Chinese character in the training sample comprises:
determining a training writing mode of the training Chinese characters according to a number of the at least one training Chinese character; and
training the pre-constructed neural network model according to the writing trajectory of the training Chinese character, the training label of the training Chinese character and the training writing mode of the training Chinese character.

10. The method according to claim 9, wherein the training the pre-constructed neural network model according to the writing trajectory of the training Chinese character, the training label of the training Chinese character and the training writing mode of the training Chinese character comprises:
determining a label code feature of the training Chinese character according to both the training writing mode and the training label of the training Chinese character; and
training the pre-constructed neural network model according to the label code feature of the training Chinese character and a content code feature corresponding to the writing trajectory of the training Chinese character.

11. The method according to claim 10, wherein the determining a label code feature of the training Chinese character according to both the training writing mode and the training label of the training Chinese character comprises:
encoding the training label of the training Chinese character to obtain an initial code feature of the training Chinese character;
encoding the training writing mode of the training Chinese character to obtain a mode code feature of the training Chinese character; and
performing feature fusion on the initial code feature of the training Chinese character and the mode code feature of the training Chinese character to obtain the label code feature of the training Chinese character.

12. The method according to claim 9, wherein the determining a training writing mode of the training Chinese characters according to a number of the at least one training Chinese character comprises:
in response to the number of the at least one training Chinese character being greater than 1, determining the training writing mode of the at least one training Chinese character to be a multi-character writing mode; and
in response to the number of the at least one training Chinese character being equal to 1, randomly determining the training writing mode of the at least one training Chinese character to be a multi-character writing mode or a single-character writing mode.

13. A trajectory recognition method, comprising:
acquiring a to-be-recognized trajectory;
determining a code prediction result of the to-be-recognized trajectory according to a trajectory recognition model; and
determining a Chinese character recognition result corresponding to the code prediction result according to a preset code library;
wherein the trajectory recognition model is obtained by:
acquiring a training sample; and
training a pre-constructed neural network model according to both a writing trajectory and a training label of each of at least one training Chinese character in the training sample to obtain a trajectory recognition model;
wherein the training sample is obtained by the followings:
determining a code result of a training Chinese character according to a preset code library; wherein the preset code library is generated based on code characters in a five-stroke code corpus;
taking the code result as a training label of the training Chinese character; and
generating a training sample according to both a writing trajectory and a training label of the training Chinese character.

14. The method according to claim 13, further comprising:
acquiring a prediction writing mode of the to-be-recognized trajectory;
wherein the determining a code prediction result of the to-be-recognized trajectory according to a trajectory recognition model comprises: determining the code prediction result of the to-be-recognized trajectory according to the to-be-recognized trajectory and the predicted writing mode based on the trajectory recognition model.

15. The method according to claim 14, wherein the determining the code prediction result of the to-be-recognized trajectory according to the to-be-recognized trajectory and the predicted writing mode based on the trajectory recognition model comprises:
in response to the prediction writing mode being a multi-character writing mode, taking a preset start character and a recognized code prediction result as a prediction label; and
inputting the prediction label and the to-be-recognized trajectory into the trajectory recognition model to obtain a code prediction result of current recognition;
wherein a recognized code prediction result corresponding to initial recognition is null.

16. The method according to claim 15, further comprising: in response to the code prediction result of the current recognition being a preset stop character, stopping determining the code prediction result of the to-be-recognized trajectory.

17. An electronic device, comprising:
at least one processor; and
a memory communicatively connected to the at least one processor;
wherein the memory stores instructions executable by the at least one processor, wherein the instructions are executed by the at least one processor to enable the at least one processor to perform any one of the training sample generation method according to claim 1.

18. A non-transitory computer-readable storage medium storing computer instructions, wherein the computer instructions are used for enabling a computer to perform any one of the training sample generation method according to claim 1.
